(19) United States
(12) Patent Application Publication
(10) Pub. No.: US 2007/0019822 A1
(43) Pub. Date: Jan. 25, 2007

(54) Audio apparatus and control method thereof

(75) Inventors: Young-joo Seo, Suwon-si (KR); Byoung-gun Choi, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/442,295

(22) Filed: May 30, 2006

(30) Foreign Application Priority Data
Jul. 25, 2005 (KR) 2005-0067552

(51) Int. Cl. H04B 3/00

(52) U.S. Cl. 381/81

(57) ABSTRACT

An audio apparatus comprising a speaker to output an audio signal. The apparatus comprises an audio signal receiver which receives an input audio signal, a signal processor for processing the input audio signal and providing an output audio signal, an audio connection terminal to which the output audio signal processed in the signal processor is output, and a controller for determining whether an external device is connected to the audio connection terminal. The audio apparatus controls the signal processor to output the output audio signal to the audio connection terminal when it is determined that the external device is connected to the audio connection terminal. Thus, the present invention provides an audio apparatus which is capable of improving sound quality of an output audio signal by selectively outputting the audio signal, and a control method thereof.

### CROSS-REFERENCE TO RELATED APPLICATIONS

This application claims the benefit under 35 U.S.C. §119(a) of Korean Patent Application No. 2005-0067552, filed on Jul. 25, 2005, in the Korean Intellectual Property Office, the entire disclosure of which is hereby incorporated by reference.

### BACKGROUND OF THE INVENTION

1. Field of the Invention

The present invention relates to an audio apparatus and a control method thereof. More particularly, the present invention relates to an audio apparatus having an audio connection terminal for outputting an audio signal, where the audio signal may be 5.1 channel or greater, and a control method thereof.

2. Description of the Related Art

Recently, with the development of digital video and sound systems, home theater systems have been put in residential use by users who wish to delight in three dimensional surround sound in theaters at their home.

Such a home theater system typically uses an audio signal of 5.1 channel (consisting of one woofer and 5 speakers) or more which allows a user to experience sound closer to natural sound, having both space and directional sense.

A conventional audio apparatus includes an audio connection terminal for outputting an audio signal where the audio signal may be of 5.1 channel or more. The apparatus also includes its own speaker. However, when a user connects an external device to the audio connection terminal, the conventional audio apparatus has a problem in that the sound is output not only to the audio connection terminal but also the speaker. As such, the sound is heard by the user through the external device as well as the speaker.

Accordingly, there is a need for an improved audio apparatus and control method which controls the output of the apparatus.

### SUMMARY OF THE INVENTION

Exemplary embodiments of the present invention address at least the above problems and/or disadvantages and provide at least the advantages described below. Accordingly, it is an aspect of an exemplary embodiment of the present invention to provide an audio apparatus, which is capable of improving sound quality of an output audio signal by preventing the audio signal from being output to an audio connection terminal for outputting the audio signal, where the signal may be of 5.1 channel or more, and a speaker simultaneously, and a control method thereof.

An exemplary aspect of the present invention is achieved by providing an audio apparatus comprising a speaker to output an audio signal and further comprising an audio signal receiver for receiving an input audio signal. A signal processor processes the input audio signal. An audio connection terminal receives an output audio signal, which may be of 5.1 channel or more, processed in the signal processor. A controller determines whether an external device is connected to the audio connection terminal and controls the signal processor to output the output audio signal to the audio connection terminal without being output to the speaker when it is determined that the external device is connected to the audio connection terminal.

According to an exemplary embodiment of the present invention, the signal processor comprises a switch for switching the audio signal applied to the speaker, and the controller controls switching of the switch so as not to output the audio signal to the speaker if it is determined that an external device is connected to the audio connection terminal.

According to an exemplary embodiment of the present invention, the audio connection terminal comprises at least one of an SPDIF terminal and an optical cable terminal.

According to an exemplary embodiment of the present invention, the controller controls the signal processor to output the output audio signal through the speaker and the audio connection terminal when it is determined that an external device is not connected to the audio connection terminal.

According to an exemplary embodiment of the present invention, the audio signal receiver receives the input audio signal contained in a broadcasting signal.

An exemplary aspect of the present invention is achieved by providing a method of controlling an audio apparatus including a speaker to output an output audio signal and an audio connection terminal to output an output audio signal, which may be a signal of 5.1 channel or more. The method comprises receiving an input audio signal from an external source, determining whether an external device is connected to the audio connection terminal and outputting an output audio signal to the audio connection terminal without being output to the speaker when it is determined that the external device is connected to the audio connection terminal.

According to an exemplary embodiment of the present invention, the method further comprises outputting the output audio signal to the speaker and the audio connection terminal when it is determined that the external device is not connected to the audio connection terminal.

### BRIEF DESCRIPTION OF THE DRAWINGS

The above and/or other aspects and advantages of the present invention will become apparent and more readily appreciated from the following description of the embodiments, taken in conjunction with the accompanying drawings of which:

FIG. 1 is a control block diagram of an audio outputting apparatus according to an exemplary embodiment of the present invention;

FIG. 2 is a detailed block diagram of a signal processor according to an exemplary embodiment of the present invention; and

FIG. 3 is a control flow chart illustrating operation of an audio outputting apparatus according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Reference will now be made in detail to exemplary embodiments of the present invention, examples of which are illustrated in the accompanying drawings.

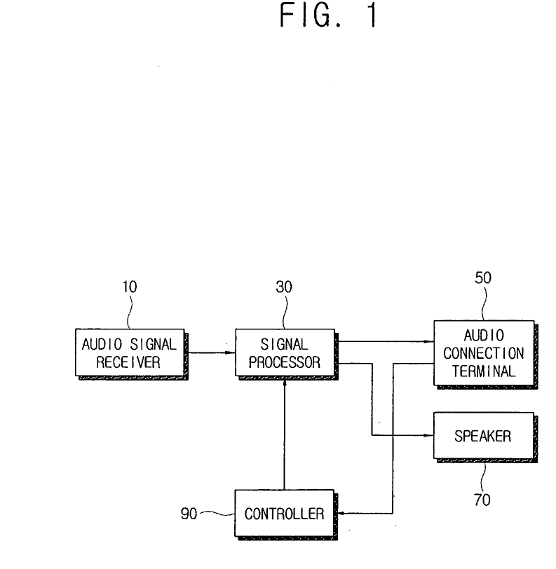

Referring to FIG. 1, an audio apparatus of the present invention includes an audio signal receiver 10 for receiving an input audio signal from an external source, a signal processor 30 for processing the input audio signal, an audio connection terminal 50 to which an output audio signal is provided, a speaker 70 for outputting the audio signal, and a controller 90 for controlling these components. The output audio signal may be a signal of 5.1 channel or more.

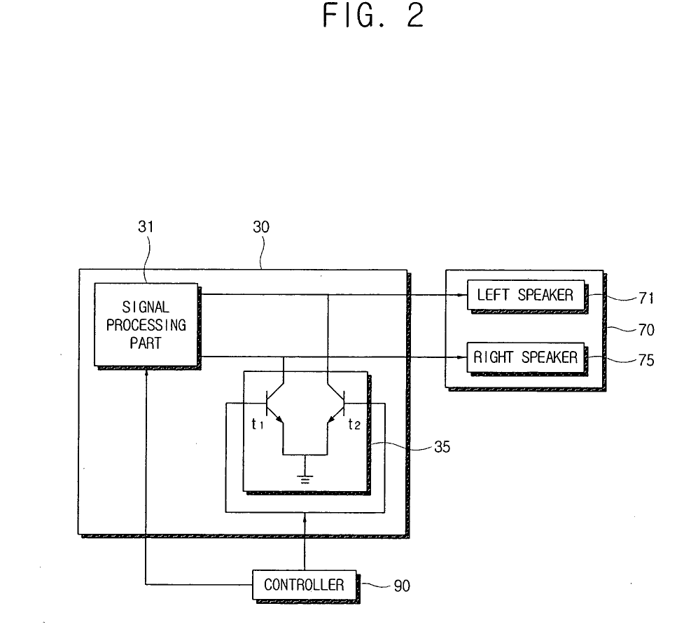

The speaker 70 outputs the output audio signal received from the signal processor 30, which will be described in detail later, provided in the audio apparatus. The audio apparatus may include at least one speaker 70, which may further include a left speaker 71 (see FIG. 2) and a right speaker 75 (see FIG. 2).

The audio connection terminal 50 is a terminal for outputting the audio signal. The audio connection terminal 50 may generally include terminals for outputting an audio signal of 5.1 channel or more, for example, a SPDIF (Sony/Philips Digital Interface) terminal, an optical cable terminal, or the like.

The audio signal receiver 10 receives an input audio signal from an external source. Here, the audio signal receiver 10 may have various forms of audio input terminals for receiving the input audio signal from the external source.

For example, the audio signal receiver 10 may include an input jack for receiving the audio signal output from the external source. Such a jack may include at least one of a mini plug input terminal to which a mini plug connected to an external device is connected, an audio composite terminal to which an audio composite jack connected to the external source is connected, and the like.

Alternatively, the audio signal receiver 10 may include a tuner to receive a broadcasting signal, which may contain an audio signal, from the external source, for example, a broadcasting station.

The signal processor 30 processes the audio signal received from the audio signal receiver 10 to output the processed audio signal to the speaker 70 and the audio connection terminal 50.

Here, the signal processor 30 may include a signal processing part 31 (see FIG. 2) including an audio codec for decoding the input audio signal received from the audio signal receiver 10 and an audio amplifier for amplifying the output audio signal received from the audio codec.

In addition, the signal processor 30 may further include a signal switch 35 for switching the output audio signal, as shown in FIG. 2. The signal switch 35 can switch the output audio signal to be output to the left speaker 71 and the right speaker 75. Here, the signal switch 35 is preferably a transistor, but is not limited to this. For example, the signal switch 35 may be a relay.

The controller 90 controls the above-mentioned components such that the output audio signal is output to at least one of the audio connection terminal 50 and the speaker 70.

The controller 90 determines whether or not an external device is connected to the audio connection terminal 50 and controls the signal processor 30 such that the output audio signal is not output to the speaker if an external device is connected to the audio connection terminal 50. Here, the controller 90 may include a detector (not shown) for detecting whether or not an external device is connected to the audio connection terminal 50. The detector may include a pull-up resistor connected to the audio connection terminal 50, for example. In this case, the audio connection terminal 50 is grounded if the external device is not connected to the audio connection terminal 50. It may be configured such that a high level signal is output from one end of the pull-up resistor if the grounded audio connection terminal is not connected to the one end of the pull-up resistor. And then a low level signal is output from the one end of the pull-up resistor if the grounded audio connection terminal is connected to the one end of the pull-up resistor when the external device is connected to the grounded audio connection terminal. However, such a configuration is merely exemplary and is non-limiting. The high and low level signals generated may be changed according to a circuit configuration.

If it is determined that an external device is not connected to the audio connection terminal 50, the controller 90 controls the signal processor 30 such that the output audio signal is output to the speaker 70. The controller 90 may cause the output audio signal to be output to the audio connection terminal 50 as well as the speaker 70. According to an exemplary embodiment of the present invention, the controller 90 controls switching of the signal switch 35 included in the signal processor 30. Here, when the signal switch 35 is provided as shown in FIG. 2, the controller 90 switches off switches t₁ and t₂ of the signal switch 35. Then, the audio signal output from the signal processing part 31 is output to the speaker 70.

When an external device is connected to the audio connection terminal, the controller 90 controls the signal processor 30 such that the output audio signal is not output to the speaker 70. According to an exemplary embodiment of the present invention, the controller 90 controls the signal switch 35 such that the output audio signal output from the signal processing part 31 is not output to the speaker 70. In other words, when the signal switch 35 is provided as shown in FIG. 2, the controller 90 switches on the switches t₁, and t₂ of the signal switch 35. Then, since the output audio signal, output from the signal processing part 31, flows into a ground through the switches t₁ and t₂, the output audio signal is not output to the speaker 70.

According to another exemplary embodiment, when the external device is connected to the audio connection terminal 50, the magnitude of the output audio signal to be output to the speaker 70 may be reduced, or the output audio signal to be output to the speaker 70 may be controlled in a way that the switches t₁ and t₂ are differently configured.

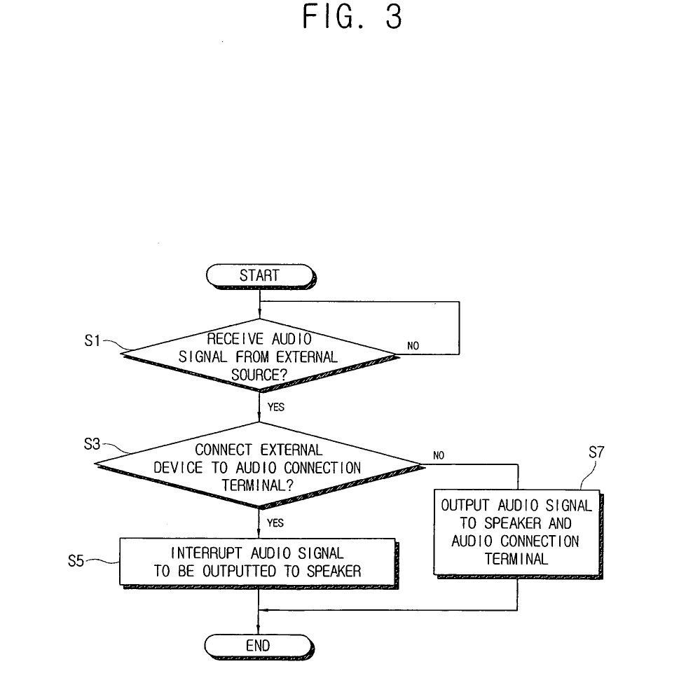

Referring to FIG. 3, the audio apparatus of the present invention receives the input audio signal from an external source at operation S1. The received input audio signal is processed in the signal processing part 31 such that an output audio signal can be output to the speaker 70.

The controller 90 determines whether or not the external device is connected to the audio connection terminal 50 at operation S3. If it is determined that an external device is not connected to the audio connection terminal 50, the controller 90 controls the output audio signal to be output to the audio connection terminal 50 at operation S7. As described above, the controller 90 controls the signal switch 35 included in the signal processor 30 such that the output audio signal is output to the speaker 70.

If it is determined that an external device is connected to the audio connection terminal 50, the controller 90 controls the signal processor 30 such that the output audio signal is output to the audio connection terminal 50 at operation S5. In addition, the controller 90 controls the signal processor 30 such that the output audio signal is not output to the speaker at operation S5. In this case, the controller 90 controls the switches of the signal switch 35 such that the output audio signal is not output to the speaker 70.

The audio apparatus of the present invention may be a television that receives the input audio signal contained in a broadcasting signal received from the external source, for example, a broadcasting station. However, the audio apparatus is not limited and may comprise any apparatus that includes an audio connection terminal 50 for outputting an output audio signal.

The conventional audio apparatus has a problem in that the audio signal is output to the speaker 70 and an external device simultaneously. On the contrary, as described above, in an exemplary audio apparatus of the present invention, when an external device is connected to the audio connection terminal 50 for outputting an output audio signal, the audio signal is output only to the audio connection terminal 50 and not to the speaker 70. Accordingly, as the audio signal is selectively output from one of the speaker 70 and the external device, a user can hear sound of better quality.

As apparent from the description, an exemplary embodiment of the present invention provides an audio apparatus, which is capable of improving sound quality of the output audio signal by preventing the output audio signal from being output to the audio connection terminal for outputting the audio signal and a speaker simultaneously, and a control method thereof.

Although exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. An audio apparatus comprising a speaker to output an audio signal, comprising:
an audio signal receiver for receiving an input audio signal;
a signal processor for processing the input audio signal and providing an output audio signal;
an audio connection terminal to which the output audio signal processed in the signal processor is provided; and
a controller for determining whether an external device is connected to the audio connection terminal and controlling the signal processor to output the audio signal to the audio connection terminal without being output to the speaker when it is determined that the external device is connected to the audio connection terminal.

2. The audio apparatus according to claim 1, wherein the signal processor comprises a switch for switching the output audio signal, and
the controller controls switching of the switch.

3. The audio apparatus according to claim 2, wherein the audio connection terminal comprises at least one of a SPDIF terminal and an optical cable terminal.

4. The audio apparatus according to claim 1, wherein the audio connection terminal comprises at least one of a SPDIF terminal and an optical cable terminal.

5. The audio apparatus according to claim 1, wherein the controller controls the signal processor to output the output audio signal to the speaker and the audio connection terminal when it is determined that an external device is not connected to the audio connection terminal.

6. The audio apparatus according to claim 1, wherein the audio signal receiver receives an input audio signal contained in a broadcasting signal.

7. A method of controlling an audio apparatus having an audio connection terminal comprising:
receiving an input audio signal from an external source;
determining whether an external device is connected to the audio connection terminal; and
outputting an output audio signal to the audio connection terminal when it is determined that an external device is connected to the audio connection terminal.

8. The method according to claim 7, further comprising outputting the audio signal to the audio connection terminal when it is determined that an external device is not connected to the audio connection terminal.

9. The audio apparatus according to claim 1, wherein the output audio signal comprises a signal of 5.1 channel or more.

10. The audio apparatus according to claim 1, wherein the controller controls the signal processor to output the output audio signal to the speaker when it is determined that an external device is not connected to the audio connection terminal.

11. The method according to claim 7, wherein outputting an output audio signal comprises outputting the output audio signal to a speaker when it is determined that an external device is not connected to the audio connection terminal.
